(19) United States
(12) Patent Application Publication
(10) Pub. No.: US 2026/0219852 A1
(43) Pub. Date: Jul. 30, 2026

(54) REMOTELY DEPLOYING ARTIFICIAL INTELLIGENCE MODELS AND A DEPENDENCY FRAMEWORK ENABLING LINE OF BUSINESS APPLICATIONS

(71) Applicant: DELL PRODUCTS L.P., Round Rock, TX (US)

(72) Inventors: Srikanth Kondapi, Austin, TX (US); Prasanth K S R, Bangalore (IN); Tyler Cox, Austin, TX (US)

(21) Appl. No.: 19/037,053

(22) Filed: Jan. 24, 2025

(51) Int. Cl. G06F 8/60; G06F 8/41

(52) U.S. Cl. CPC G06F 8/60; G06F 8/433

(57) ABSTRACT

An information handling system converts an artificial intelligence model to be compatible with an endpoint management service and determine a dependency on the artificial intelligence model. The information handling system also generates a software package that includes a model management framework associated with the artificial intelligence model. The software package is compatible with the endpoint management service, and includes the converted artificial intelligence model and the dependency. In addition, the information handling system deploys the software package to a client device that is managed by the endpoint management service.

### FIELD OF THE DISCLOSURE

The present disclosure generally relates to information handling systems, and more particularly relates to remotely deploying artificial intelligence models and dependency framework enabling line of business applications.

### BACKGROUND

As the value and use of information continue to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communication among information handling systems may be via networks that are wired, wireless, or some combination.

### SUMMARY

An information handling system may convert an artificial intelligence model to be compatible with an endpoint management service and determine a dependency on the artificial intelligence model. The information handling system also may generate a software package that includes a model management framework associated with the artificial intelligence model. The software package may be compatible with the endpoint management service, and may include the converted artificial intelligence model and the dependency. In addition, the information handling system may deploy the software package to a client device that is managed by the endpoint management service.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an environment configured to remotely deploy artificial intelligence models and dependency framework which enables line of business applications, according to an embodiment of the present disclosure;

FIG. 2 is a sequence diagram of a method for enrolling a model management framework (MMF) into an endpoint management service, according to an embodiment of the present disclosure;

FIG. 3 is a sequence diagram of a method for enrolling an enterprise application at endpoint management services, according to an embodiment of the present disclosure;

FIG. 4 is a sequence diagram of a method for deployment of the enterprise application to a client device, according to an embodiment of the present disclosure;

FIG. 5 is a sequence diagram of a method for an update of an MMF and an artificial model, according to an embodiment of the present disclosure;

FIG. 6 is a flowchart of a method to remotely deploy an artificial intelligence model and dependency framework enabling line of business applications to a client device, according to an embodiment of the present disclosure; and

FIG. 7 is a block diagram illustrating an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

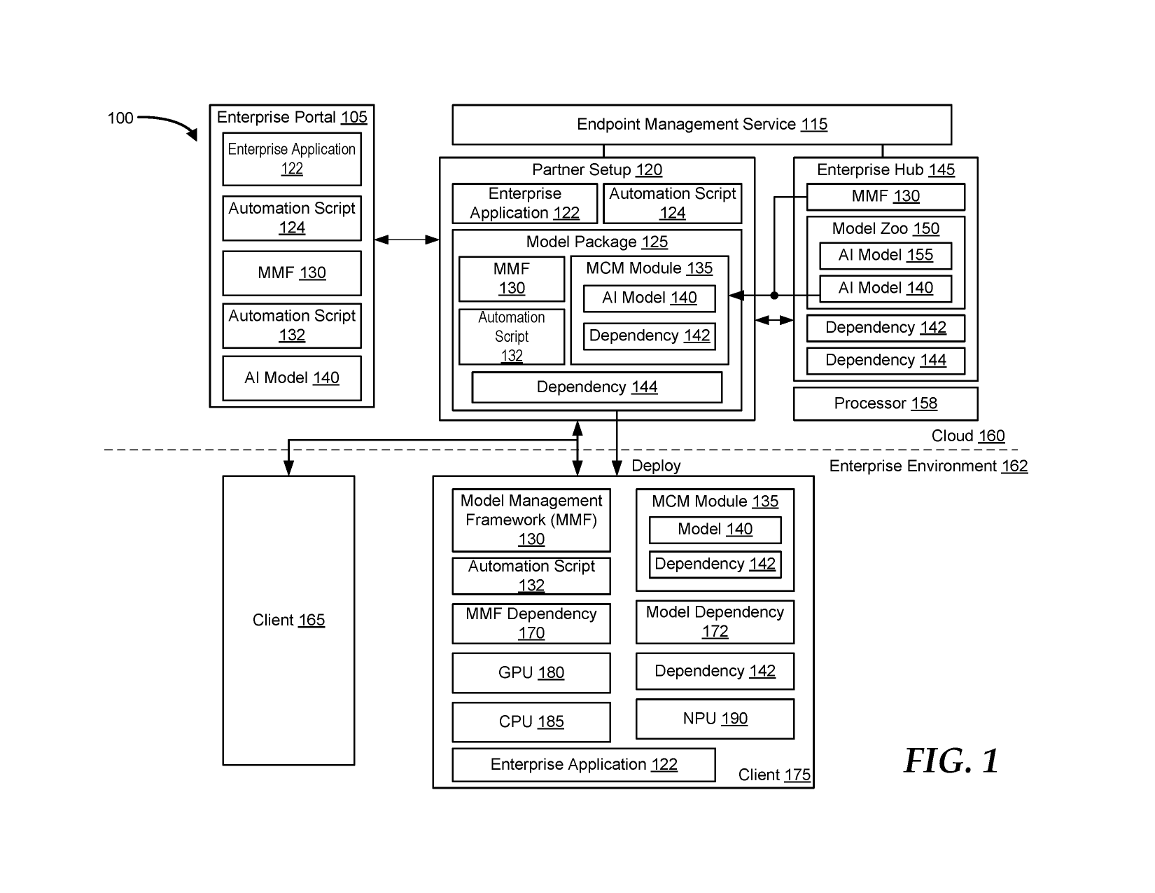

FIG. 1 illustrates a portion of an environment 100 configured to remotely deploy artificial intelligence (AI) models and dependency framework which enables line of business applications, according to an embodiment of the present disclosure. Environment 100 includes an enterprise portal 105 and an endpoint management service 115 which are both located at a cloud 160. The enterprise which is associated with enterprise portal 918 may manage client devices in an enterprise environment 162, such as clients 165 and 175. Enterprise portal 105 may be communicatively coupled to endpoint management service 115 which is communicatively coupled to clients 165 and 175. In addition, other connections between components may be omitted for descriptive clarity.

Organizations, such as various enterprises, may own and/or manage a large number of information handling systems. For instance, an employer may provide laptop computers to employees and may also operate various other types of information handling systems, such as rack-mounted servers and networking equipment, in order to support the operation of the laptops. The provided laptops may be operated in a variety of scenarios, both for performing job functions and for personal use. In another example, educational institutions may support various types of information handling systems, such as tablets and laptops that are issued to students and employees. The information handling systems have different capabilities, system configurations, and silicon resources, among others. For example, some information handling systems have discrete graphics processing units (GPUs) while others have integrated GPUs. Further other information handling systems have neural processing units (NPUs).

Some line of business applications include AI applications, such as conversational AI applications, also referred to as chatbots, which are used by various enterprise client devices. For example, more and more organizations adopt chatbots to support their customers in customer service and technical support. Model management framework (MMF) and MMF converted modules (MCMs) facilitate the consumption of AI device-enabled AI capabilities within line of business applications. In an enterprise environment, an information technology administrator typically deploys line of business applications to his fleet of client devices using remote management solutions. However, tracking and/or coordinating the complex and increasing number of dependencies of applications on MMF and MCMs in a diverse AI computing ecosystem is increasingly becoming difficult.

For example, the IT administrator who is managing the deployment of an AI conversational application into local client devices may use a particular large language model (LLM). The fleet of client devices to which the AI conversational application includes both x64 architecture and advanced RISC machine (ARM) systems. In addition, only a subset of the client devices has the latest NPUs to support the LLM locally. In addition, the AI conversational application has a dependency on a base model framework and an LLM model bundle as representation state transfer (REST) endpoints among other application programming interfaces (APIs) that are consumed by the application. As such, the IT administrator has a complex task of ensuring that the requirements of the AI conversational application are met at each one of the client devices in the fleet. To address these and other concerns, the present disclosure provides a system and method for remotely deploying AI models and dependency framework, also referred to as an MMF, to enable line-of-business applications with AI capabilities.

Enterprise portal 105 may be designed to allow an administrator to access and perform a function associated with endpoint management service 115. For example, the administrator may manage various resources via endpoint management service 115 via enterprise portal 105. Enterprise portal 105 may be a webpage, an application, or a special purpose workspace, among others of an enterprise that is a partner of endpoint management service 115 in managing its resources. In one embodiment, the administrator may be configured to download software resources, such as an enterprise application 122, an automation script 124, an MMF 130, an automation script 132, and an AI model 140 from an enterprise hub 145. The software resources may be accessible by the administrator via a partner setup 120.

Endpoint management service 115 may be a cloud-based unified endpoint management service, such as Microsoft Intune®. Endpoint management service 115 may have several organizations or enterprise partners that manage their resources via endpoint management service 115. Each one of the partners may have their instance setup, such as a partner setup 120 that allows an administrator of the partner access to various features or functions of endpoint management service 115. Partner setup 120 may be an instance of a partner that has a subscription with endpoint management service 115. Partner setup 120 allows the administrator of the enterprise to perform various functions, such as managing devices, uploading, and downloading applications, MCMs, etc., among other functions. For example, the administrator may download an application to be deployed to its managed client devices, such as enterprise application 122. Enterprise application 122 may be an application with AI capabilities that may be deployed to various clients in enterprise environment 162, such as clients 165 and 175. The administrator may also download an automation script, such as automation script 124 to assist with the deployment of the application.

Automation script 124 may be any suitable software application, script, or similar for MMF and MCM deployment. Automation script 124 may be executed by an administrator of enterprise environment 162 within a setup configured inside endpoint management service 115, such as partner setup 120. In one embodiment, automation script 124 may be configured to check or discover versions of MMF 130 and AI models 140 and 155 using various query methods, such as via regex patterns in the name or description of the application. In one example, automation script 124 may determine that the version of MMF 130 is compatible with AI models 140 and 155, thus MMF 130 can be associated with AI models 140 and 155. Automation script 124 may also be configured to determine or scan for dependencies of MMF 130 and AI models 140 and 155 if any. In one embodiment, automation script 1224 may determine the aforementioned by various means, such as parsing metadata associated with MMF 130 and AI models 140 and 155.

In addition, automation script 124 may generate a software package, such as a software package 125 that includes the MMF, one or more MCMs and their dependencies. The software package may be used to deploy the MMF and/or MCMs, to client devices. For example, enterprise application 122 may require a particular MMF version and AI model along with one or more dependencies. The dependency can be an application, another MMF, another artificial intelligence model, a script, etc. In one embodiment, automation script 124 may determine that MMF 130, AI model 140, and a dependency 144 are requirements of enterprise application 122. In addition, automation script 124 may determine that AI model 140 has a dependency on dependency 142. As such, automation script 124 may create software package 125 to include the above requirements. In addition, automation script 124 may convert AI model 140 and its dependency 142 to a module that is compatible with MMF 130 and/or endpoint management service 115, generating MCM module 135 in the process.

Further, automation script 124 may include an installer, such as a .msi file in addition to automation script 132 which may be used to automate deployment of software package 125 to various client devices, such as client 175. In another embodiment, automation script 132 may also be configured as the installer. A partner organization that owns partner setup 120 may then publish software package 125 for deployment to its client devices. As such, automation script 124 may be configured to determine the required dependencies of enterprise application 122 and generate the software package that includes those dependencies. Due to bloat concerns, automation script 124 may generate software package 125 as a single unit, wherein each package includes one MMF version. If enterprise application 122 requires more than one MMF version, then automation script 124 may generate more than one software package.

MMF 130 may be configured to include technologies that help the enterprise manage artificial intelligence models. MMF 130 may include artificial intelligence and/or machine learning algorithms, artificial intelligence, and/or machine learning models, and one or more dependencies, among others. In one embodiment, during deployment to client 175, if the required MMF version or AI model version is not found, then automation script 132 may return an error with guidance on recommended action. One action may be to determine if there is a compatible MMF version instead. If the required or compatible MMF version is found, an application globally unique identifier (GUID) corresponding to the MMF version can be inserted into dependency metadata for enterprise application 122.

Automation script 132 can be a power shell script or similar that is generated or at least a portion thereof by automation script 124 in addition to a manifest or a portion thereof. Automation script 132 may be configured to perform applicability checks or discoveries, such as architecture, operating system, system manufacturer, model, software dependencies, silicon properties, requirements of AI processing chip(s), etc. The AI processing chips include GPUs, NPUs, or similar. Automation script 132 may also be configured to detect installed MMF and MCM module versions and dependencies if any. In addition, automation script 132 may identify properties of the MMF, MCM modules, and dependencies, such as their versions. In addition, automation script 132 may handle the installation or uninstallation behavior or action associated with the deployment of software package 125 into client 175.

Automation script 132 may also determine an optimal installation path or optimal installation order of the components included in software package 125 and perform the installation accordingly, such as when there are multiple MCMs and/or dependencies in software package 125. In addition, automation script 132 may be configured to handle a deployment issue when it occurs during the performance of the behavior or action. For example, automation script 132 may handle an issue associated with a required dependency from an issue associated with an optional dependency. For example, automation script 132 may determine and download an MMF dependency 170 and a model dependency 172. Further, automation script 132 may also be configured to map custom installation code to one or more values associated with endpoint management service 115.

Enterprise hub 145 may be any suitable system, apparatus, or device operable as a repository or library of various software components and/or devices. In one example, enterprise hub 145 includes a model zoo, such as a model zoo 150. Model zoo 150 may be any suitable system, apparatus, or device operable as a repository or a library of artificial intelligence models, such as AI models 140 and 155. AI models, such as AI models 140 and 155, once trained, may provide computer-implemented services for downstream consumers. For example, trained AI models may provide inference generation for a consumer application. In this example, enterprise hub 145 also includes dependencies 142 and 144. Dependency 142 may be a dependency of AI model 140 while dependency 144 may be a dependency of MMF 130.

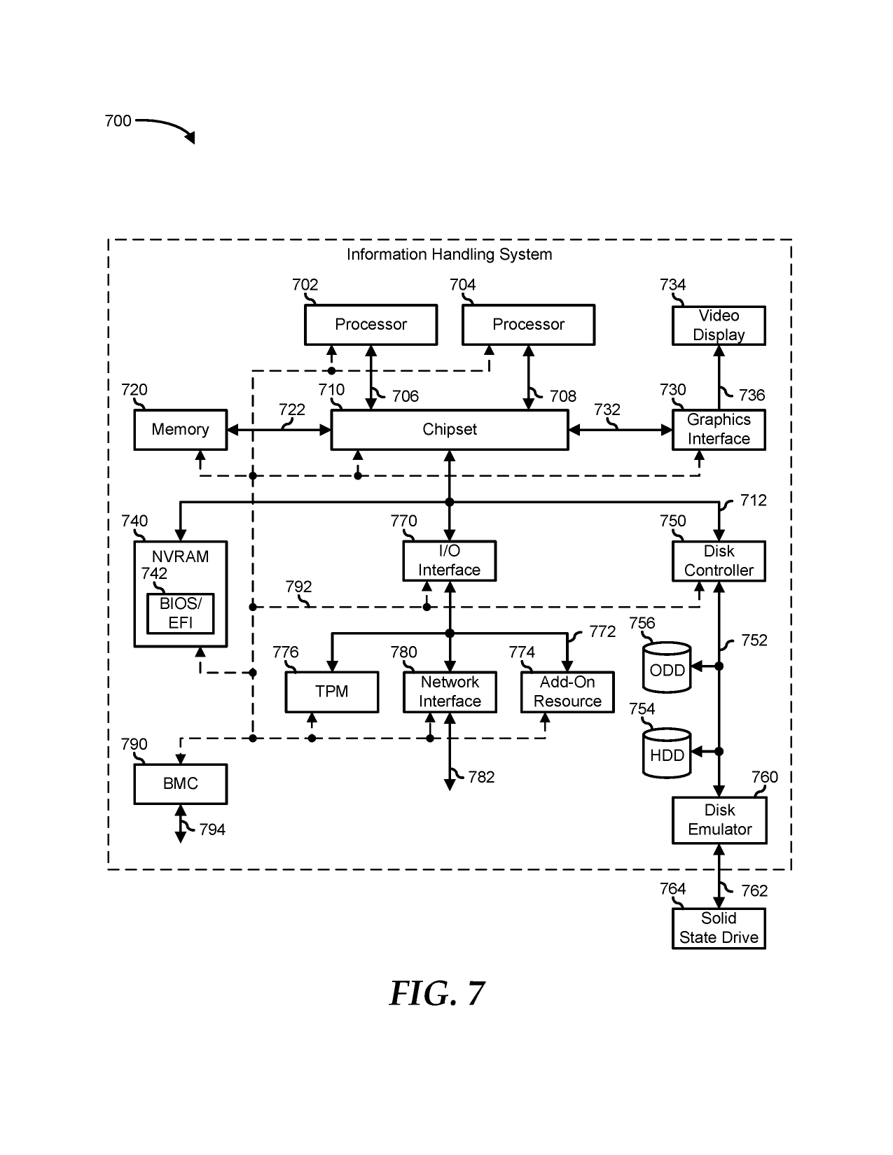

Enterprise environment 162 includes one or more clients managed by the administrator via endpoint management service 115 and owned by an enterprise that is a partner of endpoint management service. The enterprise is associated with enterprise portal 105 and partner setup 120. In this example, enterprise environment 162 includes client 165 and client 175. Clients 165 and 175 may be computing devices and/or information handling systems similar to information handling system 700 of FIG. 7. Although in this example, software package 125 is shown deployed in client 175 the model package can also be deployed in client 165.

The operations described herein as being performed by one or more components of automation scripts 124 and 132 and/or enterprise application 122 at endpoint management service 115 may be performed or executed by a processor 158, which is similar to processors 702 and 704 of FIG. 7. Similarly, a GPU 180, a CPU 185, and an NPU 190 may perform any suitable operations to execute enterprise application 122 and automation script 132 at client 175. Client 175 includes GPU 180, CPU 185, and NPU 190. GPU 180, which may be similar to graphics adapter 730 of FIG. 7 may comprise any system, device, or apparatus configured to process graphical or visual content and to communicate that content to a monitor or display where the content may be rendered. CPU 185, which is similar to processors 702 and 704 of FIG. 7, may be configured to execute instructions of an application and/or a script, such as automation script 132. CPU 185 may also be configured to execute the installer associated with software package 125 upon deployment of software package 125. In addition, CPU 185 along with GPU 180 and NPU 190 may be configured to execute consumer applications associated with MMF and/or MCM module 135, such as application intelligence applications.

NPU 190 may comprise any system, device, or apparatus, such as a hardware accelerator that is designed for artificial intelligence and machine learning tasks. In one example, NPUs, such as NPU 190 may be optimized to handle the complex computations required by deep learning algorithms. This optimization makes NPUs efficient at processing AI tasks, such as natural language processing, image analysis, and more. NPUs utilized by client 175 may be of various types including discrete NPUs and integrated NPUs.

Those of ordinary skill in the art will appreciate that the configuration, hardware, and/or software components of environment 100 depicted in FIG. 1 may vary. For example, the illustrative components within environment 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

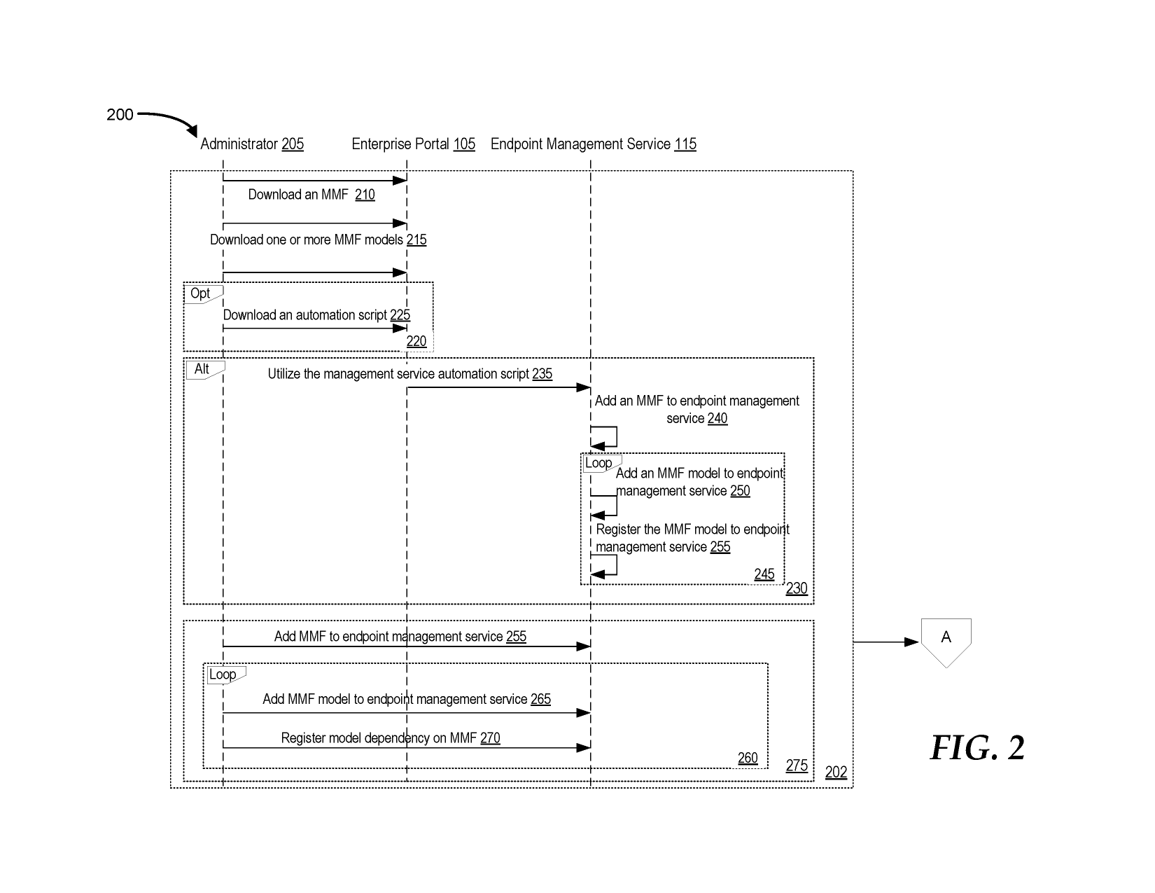

FIG. 2 shows a portion of a sequence diagram of a method 200 for enrolling an MMF into an endpoint management service, according to an embodiment of the present disclosure. Method 200 may be performed by any suitable component of environment 100 including but not limited to components associated with enterprise portal 105, endpoint management service 115, and client 175 of FIG. 1. While embodiments of the present disclosure are described in terms of the components of environment 100 of FIG. 1, it should be recognized that other components may be utilized to perform the described method. One of skill in the art will appreciate that this sequence diagram explains a typical example, which can be extended to applications or services in practice. It will be readily appreciated that not every operation set forth in this sequence diagram is always necessary and that certain operations may be combined, performed simultaneously, in a different order, or perhaps omitted, without varying from the scope of the disclosure.

Method 200 includes a block 202 which further includes blocks 220, 230, and 275. Block 230 further includes a block 245 while block 275 further includes block 260. Method 200 typically starts at an operation 210 wherein a software package that includes an MMF that is compatible with endpoint management service 115 may be downloaded to enterprise portal 105 by a user, such as an information technology administrator, such as an administrator 205. An automation script may also be used at a partner setup portal to publish MMF and MCM modules to endpoint management service 115. Subsequent to downloading the MMF, one or more MMF models that may be compatible with the MMF and endpoint management service 115 may be downloaded via enterprise portal 105 by administrator 205 at an operation 215. The MMF models include artificial learning, machine learning models, or similar, such as AI models 140 and 155 in FIG. 1. The MMF and MMF models may be stored in an enterprise hub which may be associated with an enterprise that owns the enterprise portal 105 and is in partnership with endpoint management service 115 in managing the enterprise’s computing devices or information handling systems.

Block 220, which includes an operation 225, may be optionally performed by administrator 205. At operation 225, administrator 205 may download the automation script to be executed at endpoint management service 115. Administrator 205 may utilize the automation script to publish the MMF and MMF models at block 230. Alternatively, administrator 205 may proceed to execute block 275. At operation 225, the automation script may be downloaded to enterprise portal 105. Subsequent to the download, the automation script may be utilized for a scripted publish of the MMF and/or MMF models at block 230, which includes operations 235 and 240 along with block 245. The automation script may also publish other software components associated with MMF and/or MMF models. In addition, the automation script may perform other functions, such as checking for applicability of server configuration that is hosting endpoint management service 115, discovering or detecting dependencies, and installation orders including handling uninstallation or updates, and error resolution if any.

At operation 235, the automation script may be utilized by the administrator or application to add MMF to endpoint management service 115 at operation 240. The automation script may proceed to add one or more MMF models to endpoint management service 115. The method may proceed to block 245 wherein the automation script may add each MMF model to endpoint management service 115 at an operation 250. At an operation 255, the automation script may discover and register each dependency of the MMF model to the MMF.

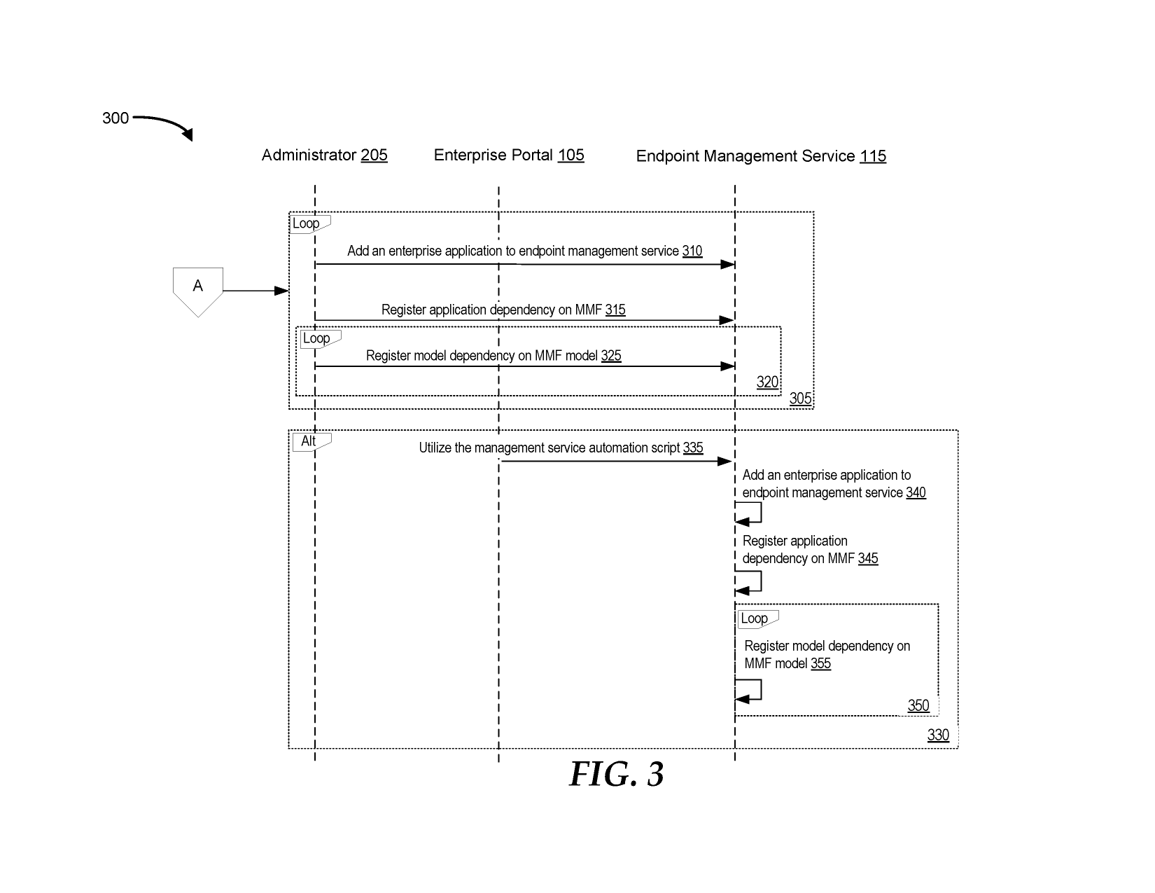

In another embodiment, the MMF may be added to endpoint management service 115 manually by the administrator or application at operation 255. Administrator 205 may also add each one of the MMF models at an operation 265. At an operation 270, the automation script may discover and register each dependency of the MMF model to the MMF. Subsequent to the execution of block 202, the method may proceed to execute a method 300 of FIG. 3.

FIG. 3 illustrates a portion of a sequence diagram of method 300 for enrolling an enterprise application at endpoint management services, according to the present disclosure. Method 300 may be performed subsequent to performing method 200 of FIG. 2. Method 300 includes a blocks 305 and 330. Block 330 includes operations 310 and 315 and a block 320 which further includes an operation 325. Block 305 may be performed for each enterprise application to be added to endpoint management service 115. Method 300 typically starts at operation 310 where an enterprise application may be deployed to endpoint management service 115 by administrator 205. The enterprise application may be an artificial intelligence and/or machine learning operation. For example, the enterprise application may be an artificial intelligence-powered chatbot or virtual assistant. The enterprise application may be deployed and executed at one or more client devices that are owned by the enterprise and managed via endpoint management service 115.

At operation 315, administrator 205 may register dependencies of the enterprise application dependency on the MMF framework at endpoint management services 115. For example, administrator 204 or the automation script may discover and register one or more MMF models as dependencies. The method may proceed to block 320 which may be performed for each MMF model that the enterprise application has a dependency on. Administrator 205 and/or the automation script may discover and register one or more dependencies of each of the MMF models at operation 325.

Block 330 includes operations 335, 340, and 345 in addition to block 350 which further includes operation 355. At operation 335, the automation script may be utilized by the administrator or application to add enterprise application to endpoint management service 115 at operation 340. At operation 345, the automation script may proceed to register application dependency on MMF at endpoint management service 115. The method may proceed to block 350, wherein the automation script may register each model dependency on MMF model to endpoint management service 115 at operation 355.

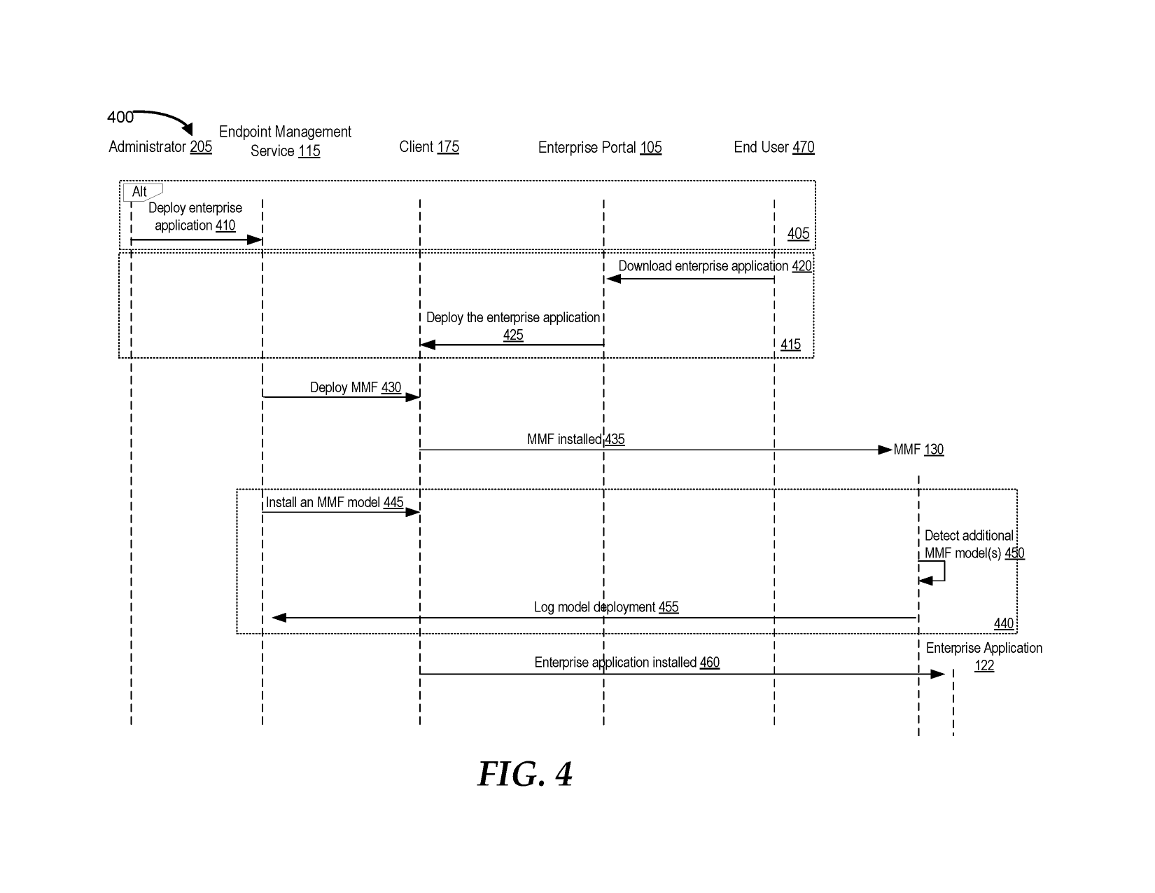

FIG. 4 illustrates a portion of a sequence diagram of a method 400 for deployment of the enterprise application to a client device, according to an embodiment of the present disclosure. Method 400 may be performed by any suitable component of environment 100 including but not limited to components associated with enterprise portal 105, endpoint management service 115, and client 175 of FIG. 1. While embodiments of the present disclosure are described in terms of the components of environment 100 of FIG. 1, it should be recognized that other components may be utilized to perform the described method. One of skill in the art will appreciate that this sequence diagram explains a typical example, which can be extended to applications or services in practice. It will be readily appreciated that not every operation set forth in this sequence diagram is always necessary and that certain operations may be combined, performed simultaneously, in a different order, or perhaps omitted, without varying from the scope of the disclosure. In one embodiment, method 400 includes blocks 405, 415, and 440. Block 405 includes an operation 410 while block 415 includes operations 420 and 425. Block in440 cludes operations 445, 450, and 455.

Method 400 typically starts at operation 410 of block 405 where administrator 205 deploys an enterprise application to endpoint management service 115. The deployment includes operations that are similar to the operations of method 300 of FIG. 3. At this point, the enterprise application may be published and available for deployment at a client device, also referred to simply as a client, which is managed by endpoint management service 115 and/or administrator 205. The method may proceed to block 415, where at operation 420 an end user 470 may deploy the enterprise application from endpoint management service 115 via enterprise portal 105 and deploy the enterprise application to client 175 at operation 425.

At an operation 430, the MMF may be downloaded from endpoint management service 115 and deployed to client 175. Prior to the deployment of the MMF, the MMF, such as MMF 130, may be included in a generated software package similar to software package 125 of FIG. 1. Subsequent to operation 430, the MMF and/or its dependencies may be installed in client 175 at a block 435. The method may proceed to operation 430 where each MMF model associated with MMF 130 may be installed along with its dependencies at operation 445, wherein additional MMF model(s) are discovered or detected at operation 450. Information associated with the deployment may be logged into operation 455. The logged information may include error(s) if any. Subsequent to the deployment of the MMF and MMF models and their dependencies, the enterprise application, such as enterprise application 122, may be installed at an operation 460.

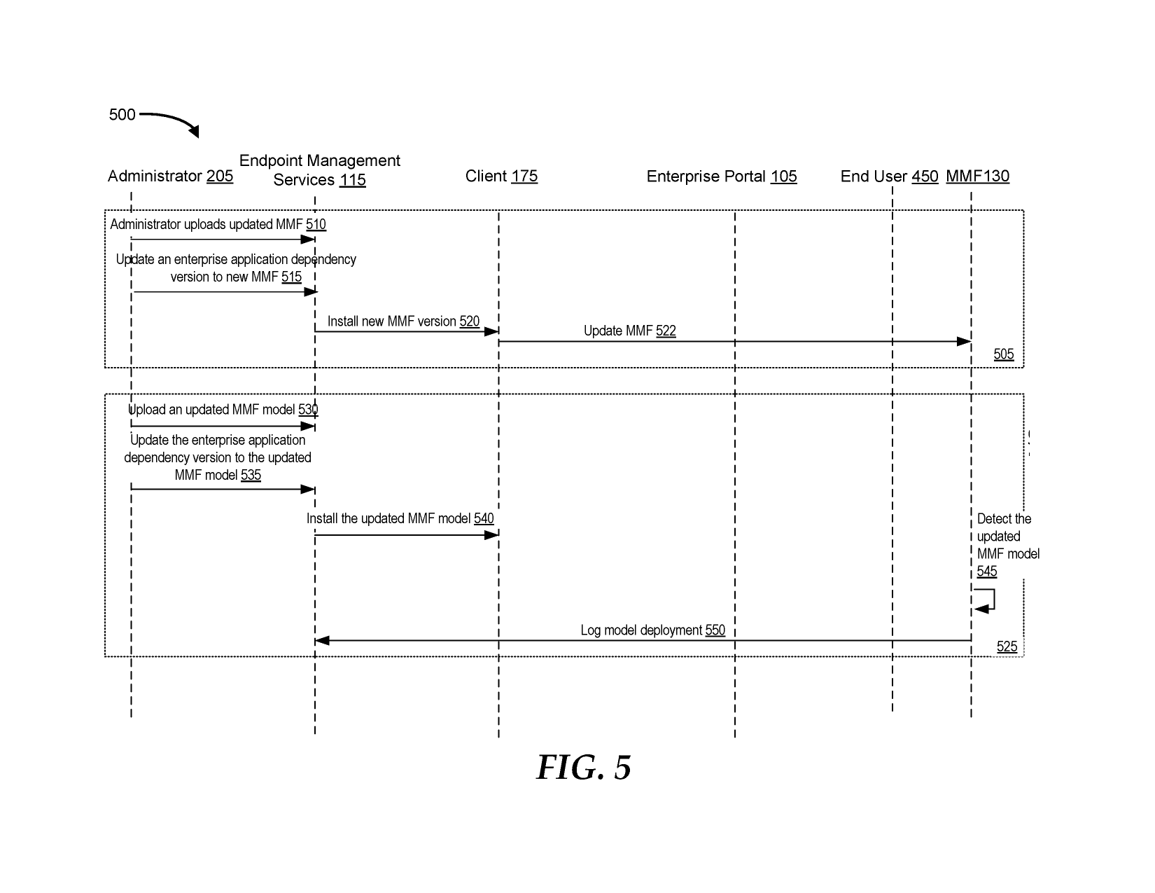

FIG. 5 illustrates a portion of a sequence diagram of a method 500 for an update of an MMF and/or MMF model, according to an embodiment of the present disclosure. Method 500 may be performed by any suitable component of environment 100 including but not limited to components associated with enterprise portal 105, endpoint management service 115, and client 175 of FIG. 1. While embodiments of the present disclosure are described in terms of the components of environment 100 of FIG. 1, it should be recognized that other components may be utilized to perform the described method. One of skill in the art will appreciate that this sequence diagram explains a typical example, which can be extended to applications or services in practice. It will be readily appreciated that not every operation set forth in this sequence diagram is always necessary and that certain operations may be combined, performed simultaneously, in a different order, or perhaps omitted, without varying from the scope of the disclosure. Method 500 includes blocks 505 and 525, wherein block 505 further includes operations 510, 515, and 520 while block 525 further includes operations 530, 535, 540, and 545.

Block 505 of method 500, which updates MMF 130, typically starts at operation 510, wherein administrator 205 may upload an updated MMF into endpoint management services 115. The updated MMF may have a newer version that the MMF published at endpoint management services 115. Subsequent to the upload, administrator 205 or an automation script may update the MMF dependency associated with the enterprise application from the older version of the MMF to the newer version at operation 515 via endpoint management services 115. For example, administrator 205 may utilize an interface associated with partner setup 120 of FIG. 1. The newer version or updated MMF may then be installed to client 175 at operation 520 and proceed to update MMF 130 at operation 522.

Subsequent to the update of MMF 130, the MMF models associated with MMF 130 may also be updated at block 525, which typically starts at operation 530, wherein administrator 205 may upload an updated MMF model to endpoint management services 115. Administrator 205 or an automation script may update the MMF model dependency of the enterprise application to the newer version of the MMF model at operation 535 via endpoint management services 115. For example, administrator 205 may utilize an interface associated with partner setup 120 of FIG. 1. At operation 540, the updated MMF model may be installed to client 175 to update the current installed MMF model to the newer version. Subsequent to the installation, MMF 130 may detect the newer version or the updated MMF model. MMF 130 may update one or more associated registries accordingly. MMF 130 may log information associated with the deployment of the updated MMF model at a block 550.

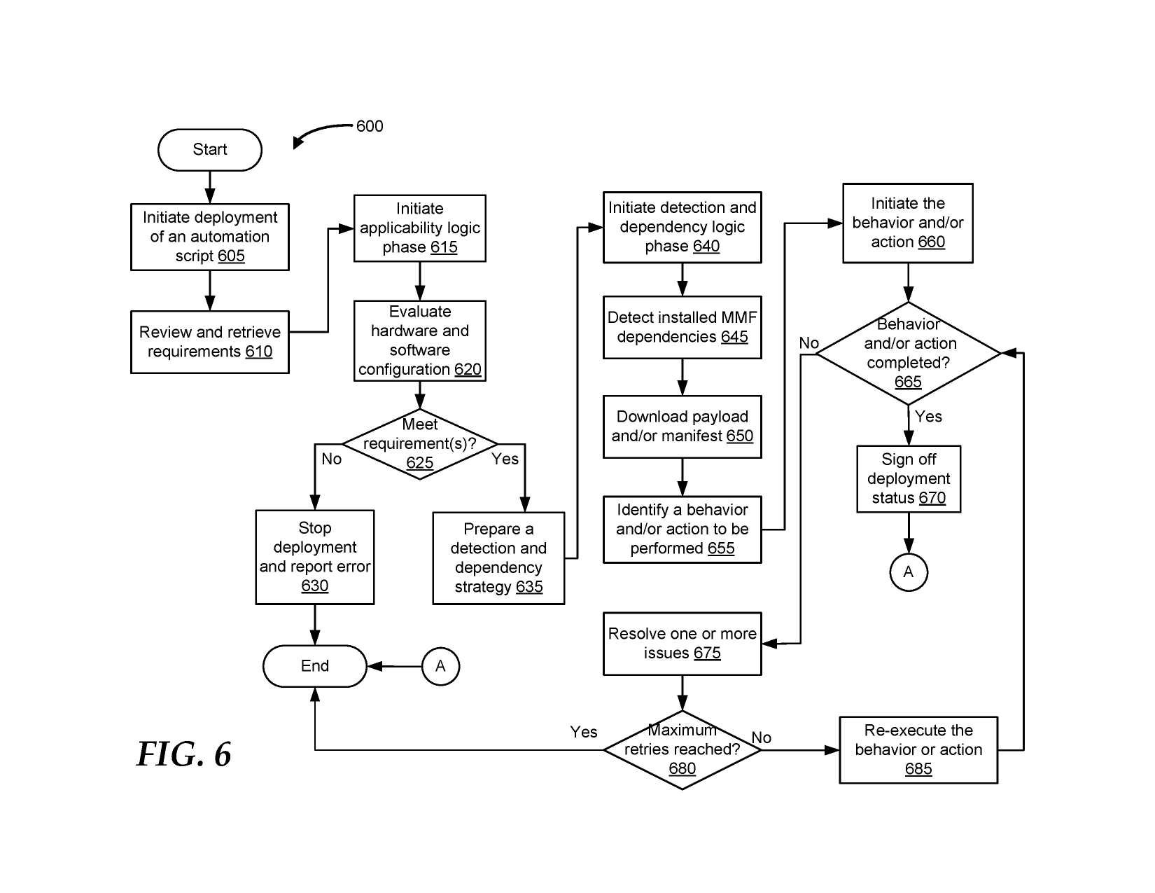

FIG. 6 illustrates a portion of a flowchart of a method 600 to remotely deploy artificial intelligence models and dependency framework enabling line of business applications to a client device, according to an embodiment of the present disclosure. In particular, method 600 may deploy a software package that includes an MMF, MCM, and associated dependencies. Method 600 may be performed by any suitable component of environment 100 including but not limited to components associated with enterprise portal 105, endpoint management service 115, and client 175 of FIG. 1. While embodiments of the present disclosure are described in terms of the components of environment 100 of FIG. 1, it should be recognized that other components may be utilized to perform the described method. One of skill in the art will appreciate that this sequence diagram explains a typical example, which can be extended to applications or services in practice. It will be readily appreciated that not every operation set forth in this sequence diagram is always necessary and that certain operations may be combined, performed simultaneously, in a different order, or perhaps omitted, without varying from the scope of the disclosure.

Method 600 typically starts at a block 605 where an administrator may deploy or initiate an automation script. In this example, the automation script may be configured to remotely deploy a software package that includes the MMF and MCM, along with one or more dependencies if any. Subsequent to the initiation, the automation script may be configured to perform other blocks of method 600. The deployment may be performed in phases, such as an applicability logic phase, a detection dependency logic phase, and a behavior performance phase. The applicability logic phase includes blocks 615, 620, 630, and 635 along with a decision block 625. The detection dependency logic phase includes blocks 640, 645, 650, and 655 along with decision blocks 665 and 680. The behavior performance phase includes blocks 660 and 670 along with decision block 665.

At a block 610, the automation script may review and/or retrieve one or more requirements of at least one MMF and its dependencies, wherein the dependencies can include one or more model abstractions also referred to as MCMs. To reduce potential bloat in building an MMF and/or MCM package, each software package is a single unit abstraction, wherein the software package includes one MMF. The automation script may be configured to discover and retrieve the requirements and/or dependencies of the MMF and MCM(s) included in the software package. For example, the automation script may retrieve and parse a manifest associated with the MMF and/or MCM(s) and obtain dependency, configuration actions, and/or other information. The manifest may be a file or a data structure that includes deployment dependencies and/or other information for deployment or installation of an MMF and/or MCMs.

The method may proceed to initiate an applicability logic phase at block 615 which includes evaluating and selecting hardware and/or software components that meet the requirements determined at block 610. For example, the automation script may evaluate whether a hardware and software configuration of the client device, such as its operating system, system architecture, memory space requirements, etc. meet the requirements of the MMF and MCM(s). For example, the automation script may determine whether the CPU of a client device is an Apple M1^{®}/M2^{®}, Intel i5^{®}/i7^{®},Qualcomm Snapdragon^{®}, etc. In addition, the automation script may determine a manufacturer of a CPU or GPU of the client device. For example, the automation script may determine whether the CPU or GPU of the client device is manufactured by Intel^{®}, AMD^{®}, or Nvidia^{®}. In another example, the automation script may determine whether the operating system of the operating system is an Apple iOS^{®}, Microsoft Windows^{®}, Linux^{®} OS, etc.

In addition, the automation script may also evaluate whether requirements of the MMF and/or MCM(s) that are not installed in the client device are available for download. The automation script may also evaluate whether older versions of the dependencies that are installed in the client device can be updated. The automation script may also determine the location of the update. The method may also evaluate whether an incompatible software, firmware, or similar can be uninstalled and a compatible one be installed instead. The method may proceed to decision block 625.

At decision block 625, the automation script may determine whether one or more requirements of the MMF and/or MCM(s) are met. If the requirement(s) are met, then the “YES” branch is taken, and the method may proceed to block 635. If the requirement(s) are not met, then the “NO” branch is taken, and the method may proceed to block 630. At block 630, the automation script may stop the deployment of the software package that includes the MMF and/or MCM(s). In addition, the automation script may generate an error report and/or log data associated with an issue with the unmet requirements. Afterwards, the method ends.

At block 635, the method may prepare a detection and dependency strategy to deploy the MMF and/or MCM(s) in the software package or a portion thereof based on the evaluation performed at block 620. For example, the automation script may determine whether the software package can be deployed in its entirety or a portion thereof, such as when the requirement(s) for the portion are met but not for the entire software package. The automation script may also install or update software, firmware, or similar dependencies prior to installing the MMF and/or MCM(s). For example, if the client device already has an older version of the MMF and/or MCM, then the method may update the MMF and/or MCM instead. The method may proceed to block 640 where the automation script may initiate the detection and dependency logic phase.

At block 645, the method may detect installed MMF and/or MCM dependencies if any. Accordingly, the method may determine whether there are dependencies that are not installed and identify a repository or location where the uninstalled dependency may be downloaded if any. For example, the method may utilize the detection and dependency strategy to identify the repository or download location, such as by parsing description or properties of the dependencies and/or associated manifest of a configuration file.

At block 650, the method may download a payload of the software package that includes an image of the MMF and/or MCM(s). In one embodiment, the payload may be an image of an uninstalled or an updated version of the dependency if any. For example, the payload may include a newer version of the MMF and/or MCM(s). In addition, the method may also download a manifest associated with the payload when available. The method may proceed to block 655 where the method may identify a behavior or action to be performed by the automation script prior to installing the MMF and/or MCM(s). For example, the behavior or action may be to install or update the MMF and/or MCM(s). In another example, the behavior or action may be to install, uninstall, update a dependency, or a combination thereof. The method may proceed to block 660 where the automation script may initiate the performance of the behavior or action. For example, the method may proceed with the installation of a dependency prior to installing the MMF and/or MCM(s). In another example, the method may update the dependency before installing the MMF and/or MCM(s).

The method may proceed to decision block 665, wherein the automation script may determine whether the behavior and/or action have been completed. If the behavior and/or action have been completed, then the “YES” branch is taken, and the method may proceed to block 670. If the behavior and/or action have not been completed, then the “NO” branch is taken, and the method may proceed to a block 675. At block 670, the method may sign off the deployment status of the software package that includes the MMF and/or MCM(s) as successful. Afterwards, the method ends.

At block 675, the automation script may resolve one or more deployment issues. For example, an alert indicating an error may be generated, logged, and/or transmitted by the automation script. Based on the error, the automation script may determine whether the issue can be resolved without user intervention. In particular, the automation script may initiate or trigger a resolution script or application to resolve the issue, wherein the resolution script or application includes known resolution step(s) for particular errors.

The method may proceed to decision block 680 where the automation script may determine whether a maximum number of retries has been reached. The maximum number of retries may be set by an administrator or set to a default number. If the maximum number of retries has been reached, then the “YES” branch is taken, and the method ends. If the maximum number of retries has not been reached, then the method may proceed to a block 685 where the automation script may re-execute the behavior or action performed at block 660 or a portion thereof. For example, the automation script may resume from a last known good status of the behavior or action. The automation script may increment a counter for each re-execution or retry.

FIG. 7 illustrates an embodiment of an information handling system 700 including processors 702 and 704, a chipset 710, a memory 720, a graphics adapter 730 connected to a video display 734, a non-volatile RAM (NVRAM) 740 that includes a basic input and output system/extensible firmware interface (BIOS/EFI) module 742, a disk controller 750, a hard disk drive (HDD) 754, an optical disk drive 756, a disk emulator 760 connected to a solid-state drive (SSD) 764, an input/output (I/O) interface 770 connected to an add-on resource 774 and a trusted platform module (TPM) 776, a network interface 780, and a baseboard management controller (BMC) 790. Processor 702 is connected to chipset 710 via processor interface 706, and processor 704 is connected to the chipset via processor interface 708. In a particular embodiment, processors 702 and 704 are connected together via a high-capacity coherent fabric, such as a HyperTransport link, a QuickPath Interconnect, or the like. Chipset 710 represents an integrated circuit or group of integrated circuits that manage the data flow between processors 702 and 704 and the other elements of information handling system 700. In a particular embodiment, chipset 710 represents a pair of integrated circuits, such as a northbridge component and a southbridge component. In another embodiment, some or all of the functions and features of chipset 710 are integrated with one or more of processors 702 and 704.

Memory 720 is connected to chipset 710 via a memory interface 722. An example of memory interface 722 includes a Double Data Rate (DDR) memory channel and memory 720 represents one or more DDR Dual In-Line Memory Modules (DIMMs). In a particular embodiment, memory interface 722 represents two or more DDR channels. In another embodiment, one or more of processors 702 and 704 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 720 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 730 is connected to chipset 710 via a graphics interface 732 and provides a video display output 736 to a video display 734. An example of a graphics interface 732 includes a Peripheral Component Interconnect-Express (PCIe) interface and graphics adapter 730 can include a four-lane (x4) PCIe adapter, an eight-lane (x8) PCIe adapter, a 16-lane (x16) PCIe adapter, or another configuration, as needed or desired. In a particular embodiment, graphics adapter 730 is provided down on a system printed circuit board (PCB). Video display output 736 can include a DVI, a HDMI, a DisplayPort interface, or the like, and video display 734 can include a monitor, a smart television, an embedded display such as a laptop computer display, or the like.

NVRAM 740, disk controller 750, and I/O interface 770 are connected to chipset 710 via an I/O channel 712. An example of I/O channel 712 includes one or more point-to-point PCIe links between chipset 710 and each of NVRAM 740, disk controller 750, and I/O interface 770. Chipset 710 can also include one or more other I/O interfaces, including a PCIe interface, an Industry Standard Architecture (ISA) interface, a Small Computer Serial Interface (SCSI) interface, an I²C interface, a System Packet Interface, a Universal Serial Bus (USB), another interface, or a combination thereof. NVRAM 740 includes BIOS/EFI module 742 that stores machine-executable code (BIOS/EFI code) that operates to detect the resources of information handling system 700, to provide drivers for the resources, to initialize the resources, and to provide common access mechanisms for the resources. The functions and features of BIOS/EFI module 742 will be further described below.

Disk controller 750 includes a disk interface 752 that connects the disc controller to a hard disk drive (HDD) 754, to an optical disk drive (ODD) 756, and disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits SSD 764 to be connected to information handling system 700 via an external interface 762. An example of external interface 762 includes a USB interface, an institute of electrical and electronics engineers (IEEE) 1394 (Firewire) interface, a proprietary interface, or a combination thereof. Alternatively, SSD 764 can be disposed within information handling system 700.

I/O interface 770 includes a peripheral interface 772 that connects the I/O interface to add-on resource 774, to TPM 776, and to network interface 780. Peripheral interface 772 can be the same type of interface as I/O channel 712 or can be a different type of interface. As such, I/O interface 770 extends the capacity of I/O channel 712 when peripheral interface 772 and the I/O channel are of the same type, and the I/O interface translates information from a format suitable to the I/O channel to a format suitable to the peripheral interface 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on a separate circuit board, or add-in card disposed within information handling system 700, a device that is external to the information handling system, or a combination thereof.

Network interface 780 represents a network communication device disposed within information handling system 700, on a main circuit board of the information handling system, integrated onto another component such as chipset 710, in another suitable location, or a combination thereof. Network interface 780 includes a network channel 782 that provides an interface to devices that are external to information handling system 700. In a particular embodiment, network channel 782 is of a different type than peripheral interface 772 and network interface 780 translates information from a format suitable to the peripheral channel to a format suitable to external devices.

In a particular embodiment, network interface 780 includes a NIC or host bus adapter (HBA), and an example of network channel 782 includes an InfiniBand channel, a Fibre Channel, a Gigabit Ethernet channel, a proprietary channel architecture, or a combination thereof. In another embodiment, network interface 780 includes a wireless communication interface, and network channel 782 includes a Wi-Fi channel, a near-field communication (NFC) channel, a Bluetooth^{®} or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 782 can be connected to an external network resource (not illustrated). The network resource can include another information handling system, a data storage system, another network, a grid management system, another suitable resource, or a combination thereof.

BMC 790 is connected to multiple elements of information handling system 700 via one or more management interface 792 to provide out-of-band monitoring, maintenance, and control of the elements of the information handling system. As such, BMC 790 represents a processing device different from processor 702 and processor 704, which provides various management functions for information handling system 700. For example, BMC 790 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 790 can vary considerably based on the type of information handling system. BMC 790 can operate in accordance with an Intelligent Platform Management Interface (IPMI). Examples of BMC 790 include an Integrated Dell^{®} Remote Access Controller (iDRAC).

Management interface 792 represents one or more out-of-band communication interfaces between BMC 790 and the elements of information handling system 700 and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 700, that is apart from the execution of code by processors 702 and 704 and procedures that are implemented on the information handling system in response to the executed code.

BMC 790 operates to monitor and maintain system firmware, such as code stored in BIOS/EFI module 742, option ROMs for graphics adapter 730, disk controller 750, add-on resource 774, network interface 780, or other elements of information handling system 700, as needed or desired. In particular, BMC 790 includes a network interface 794 that can be connected to a remote management system to receive firmware updates, as needed or desired. Here, BMC 790 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 790 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 790, an interface defined by the Distributed Management Taskforce (DMTF) (such as a Web Services Management (WSMan) interface, a Management Component Transport Protocol (MCTP) or, a Redfish^{®} interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 790 is included on a main circuit board (such as a baseboard, a motherboard, or any combination thereof) of information handling system 700 or is integrated onto another element of the information handling system such as chipset 710, or another suitable element, as needed or desired. As such, BMC 790 can be part of an integrated circuit or a chipset within information handling system 700. An example of BMC 790 includes an iDRAC, or the like. BMC 790 may operate on a separate power plane from other resources in information handling system 700. Thus BMC 790 can communicate with the management system via network interface 794 while the resources of information handling system 700 are powered off. Here, information can be sent from the management system to BMC 790 and the information can be stored in a RAM or NVRAM associated with the BMC. Information stored in the RAM may be lost after power-down of the power plane for BMC 790, while information stored in the NVRAM may be saved through a power-down/power-up cycle of the power plane for the BMC.

Information handling system 700 can include additional components and additional buses, not shown for clarity. For example, information handling system 700 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 700 can include multiple central processing units (CPUs) and redundant bus controllers. One or more components can be integrated together. Information handling system 700 can include additional buses and bus protocols, for example, I²C and the like. Additional components of information handling system 700 can include one or more storage devices that can store machine-executable code, one or more communications ports for communicating with external devices, and various input and output (I/O) devices, such as a keyboard, a mouse, and a video display.

For purposes of this disclosure, information handling system 700 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 700 can include processing resources for executing machine-executable code, such as processor 702, a programmable logic array (PLA), an embedded device such as a System-on-a-Chip (SoC), or other control logic hardware. Information handling system 700 can also include one or more computer-readable media for storing machine-executable code, such as software or data.

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

Although FIGS. 2 - 6 show example blocks of methods 200 – 600 in some implementations, methods 200 – 600 may include additional blocks, fewer blocks, different blocks, or differently arranged blocks than those depicted in FIGS. 2 - 6. Those skilled in the art will understand that the principles presented herein may be implemented in any suitably arranged processing system. Additionally, or alternatively, two or more of the blocks of methods 200 – 600 may be performed in parallel. For example, blocks 650 and 655 of method 600 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
converting, by a processor of an information handling system, an artificial intelligence model to be compatible with an endpoint management service;
determining a dependency on the artificial intelligence model;
generating, by the processor, a software package that includes a model management framework associated with the artificial intelligence model, wherein the software package is compatible with the endpoint management service, and wherein the software package includes the converted artificial intelligence model and the dependency; and
deploying the software package to a client device that is managed by the endpoint management service.

2. The method of claim 1, wherein the software package includes an automation script that is configured to check system configuration of the client device.

3. The method of claim 2, wherein the automation script is further configured to discover whether the client device includes another model management framework.

4. The method of claim 2, wherein the automation script is further configured to handle an installation order associated with the software package.

5. The method of claim 2, wherein the automation script is further configured to handle required dependencies of the model management framework.

6. The method of claim 2, wherein the automation script is further configured to handle optional dependencies of the model management framework.

7. The method of claim 1, further comprising handling a deployment error during the deploying of the software package.

8. The method of claim 7, further comprising publishing the software package for deployment to another client device that is managed by the endpoint management service and owned by a partner enterprise of the endpoint management service.

9. An information handling system, comprising:
a processor; and
a memory coupled to the processor, the memory having program instructions stored thereon that upon execution cause the processor to:
convert an artificial intelligence model to be compatible with an endpoint management service;
determine a dependency on the artificial intelligence model;
generate a software package that includes a model management framework associated with the artificial intelligence model, wherein the software package is compatible with the endpoint management service, and wherein the software package includes the converted artificial intelligence model and the dependency; and
deploy the software package to a client device that is managed by the endpoint management service.

10. The information handling system of claim 9, wherein the software package includes an automation script that is configured to check system configuration of the client device.

11. The information handling system of claim 10, wherein the automation script is further configured to discover the client device includes another model management framework.

12. The information handling system of claim 10, wherein the automation script is further configured to handle an installation order associated with the software package.

13. The information handling system of claim 10, wherein the automation script is further configured to handle required dependencies of the model management framework.

14. The information handling system of claim 10, wherein the automation script is further configured to handle optional dependencies of the model management framework.

15. A non-transitory computer-readable medium to store instructions that are executable to perform operations comprising:
converting an artificial intelligence model to be compatible with an endpoint management service;
determining a dependency on the artificial intelligence model;
generating a software package that includes a model management framework associated with the artificial intelligence model, wherein the software package is compatible with the endpoint management service, and wherein the software package includes the converted artificial intelligence model and the dependency; and
deploying the software package to a client device that is managed by the endpoint management service.

16. The non-transitory computer-readable medium of claim 15, wherein the software package includes an automation script that is configured to check system configuration of the client device.

17. The non-transitory computer-readable medium of claim 16, wherein the automation script is further configured to discover the client device includes another model management framework.

18. The non-transitory computer-readable medium of claim 16, wherein the automation script is further configured to handle installation order associated with the software package.

19. The non-transitory computer-readable medium of claim 16, wherein the automation script is further configured to handle required dependencies of the model management framework.

20. The non-transitory computer-readable medium of claim 16, wherein the automation script is further configured to handle optional dependencies of the model management framework.
